(19) United States
(12) Patent Application Publication
(10) Pub. No.: US 2009/0234825 A1
(43) Pub. Date: Sep. 17, 2009

(54) Information distribution system and information distribution method

(75) Inventors: Yingju Xia, Beijing (CN); Hao Yu, Beijing (CN); Gang Zou, Beijing (CN)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/379,779

(22) Filed: Feb. 27, 2009

(30) Foreign Application Priority Data
Feb. 28, 2008 (CN) 200810080954.2

(51) Int. Cl. G06F 17/30

(52) U.S. Cl. 707/4; 707/5; 707/E17.108

(57) ABSTRACT

The present invention relates to a system and method for information distribution services. The system comprises an inquiry condition determining component, for constructing inquiry conditions in accordance with a user input and a user model, the user model being applicable for determining features of the user; a searching component, for performing inquiry based on the inquiry conditions; an inquiry result processing component, for processing inquiry results obtained by the searching component to provide the user with processed information; and a distributing component, for distributing information compiled by the user and to be distributed.

### FIELD OF THE INVENTION

The present invention generally relates to the field of personalized information services, and more particularly, to a system and a method for providing a user with personalized information distribution.

### RELATED ART

With day-to-day expansion in network applications, requirements of netizens are incessantly updated to center around themselves to reintegrate contents, entertainments, business and communications and other various personal applications to satisfy the need of personalization to the maximum degree. With the advent of WEB 2.0 era, values of individual users are best reflected, as the great many netizens are not only creators and propagation channels of information, but are also recipients of information. Netizens actively select information, and information actively searches for suitable users. Getting online of yore might be directed to unidirectional acquisition of information, the coming of age of WEB 2.0 era sees great increase in opportunities of bidirectional intercommunication by netizens online. However, currently available services for personalization mostly tend to provide users with personalized information retrieval services, such as the personalized webpage ranking technology provided by google, the community searching services provided by yahoo web 2.0, Rollyo and MSN, the community Q&A services provided by Yahoo Answers, iAsk and Baidu knows, and the information clustering and classifying technologies provided by vivisimo, looksmart and kooxoo.

There are many documents relevant to personalized information retrieval, for instance:

“Personalized information retrieval using user-defined profile”, U.S. Pat. No. 5,761,662;

“System and method for generating personalized user profiles and for utilizing the generated user profiles to perform adaptive internet searches”, U.S. Pat. No. 6,199,067;

“System and method for personalized information filtering and alert generation”, U.S. Pat. No. 6,381,594;

“Personalized information service system”, U.S. Pat. No. 5,694,459;

“Personalized search methods”, U.S. Pat. No. 6,539,377;

“System and method for personalized search, information filtering, and for generating recommendations utilizing statistical latent class models”, U.S. Pat. No. 915,755;

“Principle and method for personalizing news feeding by analyzing novelty and dynamics of information”, China Patent Application Publication No. CN1664819;

“Personalized classification processing method and system for document browsing”, China Patent Application Publication No. CN1667607;

“Method and system for providing personalized news”, China Patent Application Publication No. CN1647527;

“International search and transfer system for providing search results personalized as specific languages”, China Patent Application Publication No. CN1503163;

“System and method for creating personalized documents in electronic mode”, China Patent Application Publication No. CN1319817;

“Searching system and searching method based on personalized information”, China Patent Application Publication No. CN1811780;

“Personalized network browsing filter”, China Patent Application Publication No. CN1529863;

“Personalized search engine method based on link analysis”, China Patent Application Publication No. CN1710560;

“Method for providing instantaneous personalized dynamic specialized services”, China Patent Application Publication No. CN1499401;

“Method for providing personalized information based on business relationship between supply and demand”, China Patent Application Publication No. CN1870026;

“Method for creating user personalized webpages”, China Patent Application Publication No. CN1932871; and

“Personalization prompted information system and method thereof”, China Patent Application Publication No. CN1602029.

Some other documents are relevant to personalized services:

“Method and apparatus for distributing personalized e-mail”, U.S. Pat. No. 6,044,395;

“Systems and methods for distributing personalized information over a communications system”, U.S. Pat. No. 7,110,994;

“System and method for automatic, real-time delivery of personalized informational and transactional data to users via high throughput content delivery device”, U.S. Pat. No. 6,671,715;

“System for personalized information distribution”, U.S. Pat. No. 7,159,029;

“System for providing personalized services”, China Patent Application Publication No. CN1302503;

“System and method for providing personalized client support”, China Patent Application Publication No. CN1630859;

“Method and apparatus for service and application personalization in communications network using user dossier web portal”, China Patent Application Publication No. CN1656482; and

“System and method for WWW-based personalization and electronic business management”, China Patent Application Publication No. CN1537282.

The foregoing documents are incorporated into the present application by reference.

However, there has been so far no application for providing users with personalized information distribution.

### SUMMARY OF THE INVENTION

To cater for the rapidly increasing requirements of network users to distribute information, the present invention proposes a system and a method for personalized information distribution to help netizens create and compile information and distribute the information to proper web sites.

In order to achieve the aforementioned objectives, the present application provides the following aspects.

Aspect 1: an inquiry system, characterized in comprising a user model component for constructing a user model to determine features of the user; and an inquiry condition determining component for constructing inquiry conditions in accordance with a user input and the user model constructed by the user model component.

Aspect 2: the system according to Aspect 1, characterized in that the user model component obtains information used for constructing the user model in a discernible or explicit mode and an indiscernible or implicit mode; wherein the discernible mode indicates registration information of the user and information required for the user to input during running process of system, and wherein the indiscernible mode indicates inquiry words frequently used by the user, web pages frequently browsed by the user, online timing, online location and/or reading convention information of the user collected in a non-interactive mode.

Aspect 3: the system according to Aspect 1, characterized in that the user model component adjusts and updates the user model in accordance with user feedback, inquiry results, user compilation results, the web site selected for distribution and information distribution tracking results.

Aspect 4: the system according to Aspect 1, characterized in further comprising one or more search engines for performing inquiry based on the inquiry conditions.

Aspect 5: the system according to Aspect 1, characterized in that the inquiry condition determining component modifies the inquiry conditions in accordance with inquiry results.

Aspect 6: an information distribution system, characterized in comprising:

an inquiry condition determining component for constructing inquiry conditions in accordance with a user input and a user model, the user model being applicable for determining features of the user;

a searching component, for performing inquiry in accordance with the inquiry conditions;

an inquiry result processing component for processing inquiry results obtained by the searching component to provide the user with processed information; and

a distributing component for distributing information compiled by the user and to be distributed.

Aspect 7: the system according to Aspect 6, characterized in that the searching component inquires samples, and the inquiry result processing component ranks the samples obtained by the searching component to provide the user with the ranked samples for the user's selective compilation.

Aspect 8: the system according to Aspect 7, characterized in that the inquiry result processing component ranks the samples obtained by the searching component to provide the user with the ranked samples for the user's selective compilation in accordance with relevancy or time, or in accordance with the number of replies for the inquired samples, times of viewing the inquired samples, and an authoritative degree of the web site to which the inquired samples belong, or in accordance with the user model.

Aspect 9: the system according to Aspect 6, characterized in that the searching component inquires samples, and the inquiry result processing component clusters the inquired samples, generates a distribution templet on the basis of the clustering, and provides the user with the distribution templet for the user's selective compilation.

Aspect 10: the system according to Aspect 6, characterized in that the clustering includes chapter-grade clustering and/or sentence-grade clustering.

Aspect 11: the system according to Aspect 6, characterized in that the search engine inquires samples, and the inquiry result processing component clusters, the inquired samples, and provides the user with ranked candidate sentences and vocabulary for the user's selection on the basis of the clustering.

Aspect 12: the system according to Aspect 6, characterized in that the search engine inquires web sites capable of performing information distribution, and the inquiry result processing component ranks the inquired web sites, and provides the user with a list of the ranked web sites.

Aspect 13: the system according to Aspect 12, characterized in that the search engine processing component ranks the inquired web sites in accordance with the user model, or authoritative degrees, degrees of vogue, numbers of users and/or geographical attributes of the web sites.

Aspect 14: the system according to Aspect 12, characterized in that the inquiry result processing component performs type recognition of the web pages before ranking, and retains only those web pages representative of the web sites.

Aspect 15: the system according to Aspect 6, characterized in further comprising an information tracking component for tracking effects after the user has distributed information by feeding back to the user replies to and/or comments on the information distributed by the user in each web site.

Aspect 16: the system according to Aspect 15, characterized in that the information tracking component transmits the tracking information to the user by RSS, email and/or online display.

Aspect 17: the system according to Aspect 15, characterized in that the information tracking component filters trash information including replies without content and meaningless replies.

Aspect 18: an inquiry method, characterized in comprising: a user inquiry inputting step for receiving inquiry conditions inputted by a user; and an inquiry condition modifying step for modifying the received inquiry conditions in accordance with a user model, the user model being capable of determining features of the user.

Aspect 19: the method according to Aspect 18, characterized in further comprising a templet information collecting step for obtaining information used for constructing the user model in a discernible mode and/or an indiscernible mode, wherein the discernible mode indicates registration information of the user and information required for the user to input during running process of system, and wherein the indiscernible mode indicates inquiry words frequently used by the user, web pages frequently browsed by the user, online timing, online location and reading convention information of the user, which are collected in a non-interactive mode; and a templet constructing step for constructing the user model in accordance with the collected templet information.

Aspect 20: the method according to Aspect 18, characterized in further comprising a templet updating step for adjusting and updating the user model in accordance with user feedback, inquiry results, user compilation results, the web site selected for distribution and information distribution tracking results.

Aspect 21: the method according to any one of Aspects 18-20, characterized in further comprising an inquiring step for performing inquiry in accordance with the modified inquiry conditions.

Aspect 22: an information distribution method, characterized in comprising:

an inquiry condition determining step, for constructing inquiry conditions in accordance with a user input and a user model, the user model being applicable for determining features of the user;

a searching step, for performing inquiry in accordance with the inquiry conditions;

an inquiry result processing step, for processing inquiry results obtained in the searching step to provide the user with processed information; and

a distributing step, for distributing information compiled by the user and to be distributed.

Aspect 23: the information distribution method according to Aspect 22, characterized in that the searching step inquires samples, and the inquiry result processing step ranks the samples obtained by searching step to provide the user with the ranked samples for the user's selective compilation.

Aspect 24: the method according to Aspect 22, characterized in that the inquiry result processing step ranks the inquired samples obtained by searching step to provide the user with the ranked samples for the user's selective compilation in accordance with relevancy or time, or in accordance with a number of replies of the inquired samples, times of views, and an authoritative degree of the web site to which the inquired samples belong, or in accordance with the user model.

Aspect 25: the method according to Aspect 22, characterized in that the searching step inquires samples, and the inquiry result processing step clusters the inquired samples, generates a distribution templet on the basis of the clustering, and provides the user with the distribution templet for the user's selective compilation.

Aspect 26: the method according to Aspect 22, characterized in that the clustering includes chapter-grade clustering and/or sentence-grade clustering.

Aspect 27: the method according to Aspect 22, characterized in that the searching step inquires samples, and the inquiry result processing step clusters the inquired samples, and provides the user with ranked candidate sentences and/or vocabulary for the user's selection on the basis of the clustering.

Aspect 28: the method according to Aspect 22, characterized in that the searching step inquires web sites capable of performing information distribution, and the inquiry result processing step ranks the inquired web sites, and provides the user with a list of the ranked web sites.

Aspect 29: the method according to Aspect 22, characterized in that the inquiry result processing step ranks the inquired web sites in accordance with the user model, or authoritative degrees, degrees of vogue, numbers of users and geographical attributes of the web sites.

Aspect 30: the method according to Aspect 22, characterized in that the inquiry result processing step performs type recognition of the web pages before ranking, and retains only those web pages representative of the web sites.

Aspect 31: the method according to Aspect 22, characterized in further comprising an information tracking step for tracking effects after the user has distributed information by feeding back to the user replies to and/or comments on the information distributed by the user in each web site.

Aspect 32: the method according to Aspect 31, characterized in that the information tracking step transmits the tracking information to the user by RSS, email and/or online display.

Aspect 33: the method according to Aspects 31 or 32, characterized in that the information tracking step filters trash information including replies without content and meaningless replies.

Aspect 34: the method according to Aspect 18, characterized in that the user model comprises a user general model and a user interest model.

The present invention further includes a computer program enabling, when executed by a computer or a logic component, the computer or the logic component to carry out the aforementioned methods, or enabling the computer or the logic component to be used as the aforementioned devices or components.

The present invention further includes a computer-readable storage medium for storing the computer program. The computer-readable storage medium can be a DVD, a floppy disk, a CD, a magnetic tape, a flash memory, and a hard disk etc.

Application of the present invention can achieve the advantageous effects of greatly reducing the time for the user to construct information, compile information and search for information. After the user has distributed information, information is fed back to the user in a plurality of modes with the trash information contained therein having been filtered, so that the user can get the feedback information quickly and in time, and it is unnecessary for the user to spend time in browsing replies at each web site after distributing the information, thereby saving time for the user to wait for feedback.

### BRIEF DESCRIPTION OF THE DRAWINGS

The aforementioned and other objectives, characteristics and advantages of the present invention can be better understood by reading the literal explanation of the invention with reference to the drawings, in which:

FIG. 1 is a schematic block diagram illustrating the information distribution system according to one embodiment of the present invention;

FIG. 2 is a schematic block diagram illustrating the user model according to one embodiment of the present invention;

FIG. 3 is a schematic block diagram illustrating the sample and templet retrieval according to one embodiment of the present invention;

FIG. 4 is a schematic block diagram illustrating the website inquiring according to one embodiment of the present invention;

FIG. 5 is a schematic block diagram illustrating the information distribution according to one embodiment of the present invention; and

FIG. 6 is a schematic block diagram illustrating the information tracking according to one embodiment of the present invention.

### DETAILED DESCRIPTION

Specific embodiments of the present invention are described in detail below with reference to the drawings. These embodiments are all exemplary in nature, and should not be construed as restrictions to the present invention.

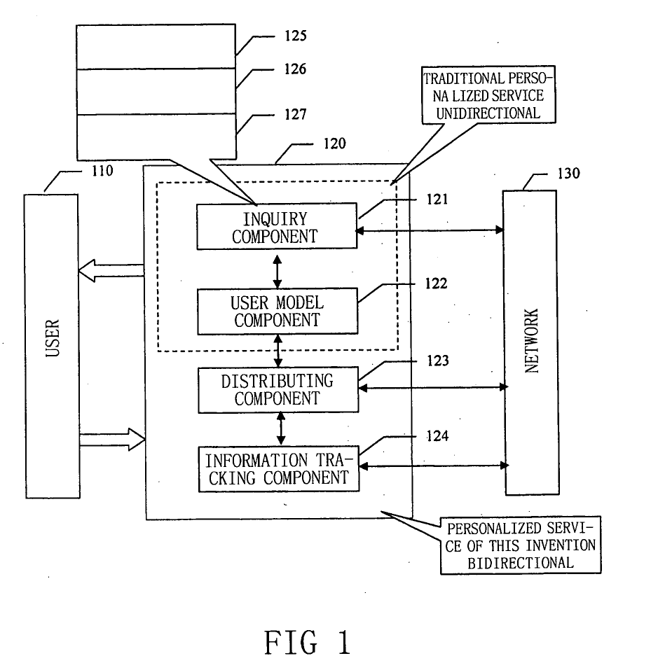

FIG. 1 is a structural diagram illustrating the information distribution system according to one embodiment of the present invention. As shown in FIG. 1, the information distribution system according to the present invention includes a user model component 122, an inquiry component 121, a distributing component 123 and an information tracking component 124.

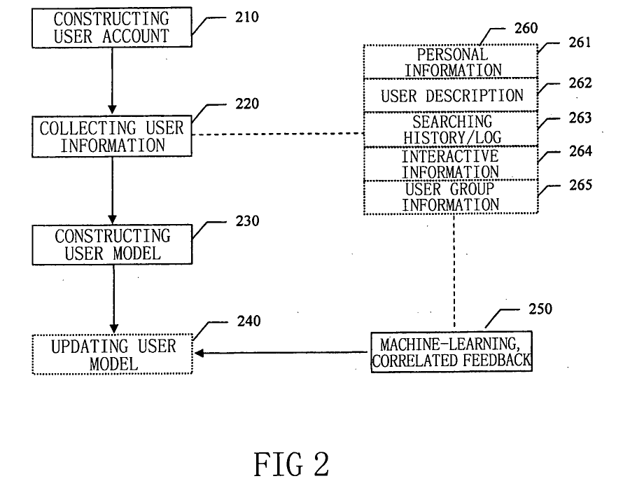

The user model component 122 constructs a user model according to the personal information of a user. A well constructed user model should be able to reflect the features and interests of the user, and be able to vary with variations in the interests of the user. FIG. 2 is a flowchart illustrating the process whereby the user model component 122 according to one embodiment of the present invention constructs a user model. The user model component 122 will be described below in more detail with reference to FIG. 2.

The inquiry component 121 determines final inquiry conditions, performs retrieval, and provides the user with websites available for information distribution or distributional samples and/or templets for the user's compilation and modification in accordance with inquiry conditions inputted by the user and the user model constructed by the user model component 122. The inquiry component 121 may include an inquiry condition determining component 125, a searching component 126, and an inquiry result processing component 127.

The inquiry condition determining component 125 receives inquiry conditions inputted by a user 110, and expands or modifies the inquiry conditions inputted by the user in accordance with the user model to determine the final inquiry conditions.

The searching component 126 can for instance be one or more search engines. Additionally, the searching component can make use of such external search tools as those provided by google and yahoo, in which circumstance the searching component can be a component that invokes these external search tools and uses these searching tools to obtain inquiry results from the host machine or a network 130. The inquiry component 121 can inquire samples (information) and websites. To inquire samples means to inquire samples already distributed; for instance, when it is intended to distribute information concerning apartment lease, the sample indicates apartment lease information already distributed by others. To inquire samples means to inquire websites available for information distribution.

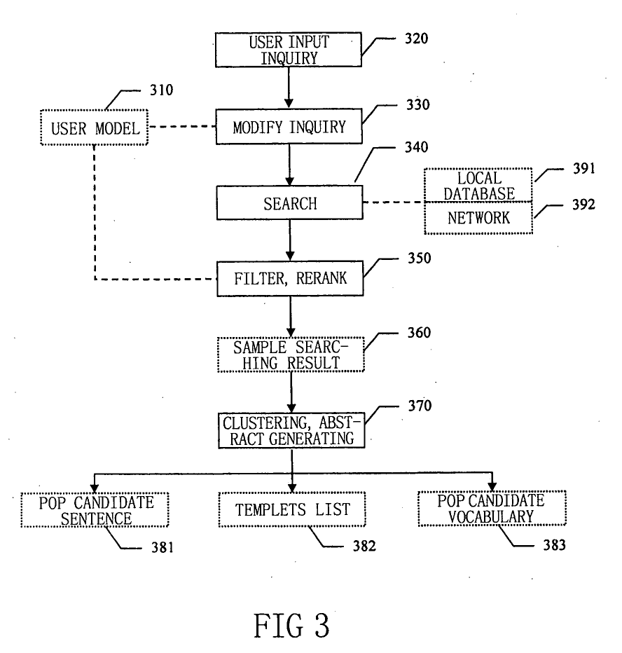

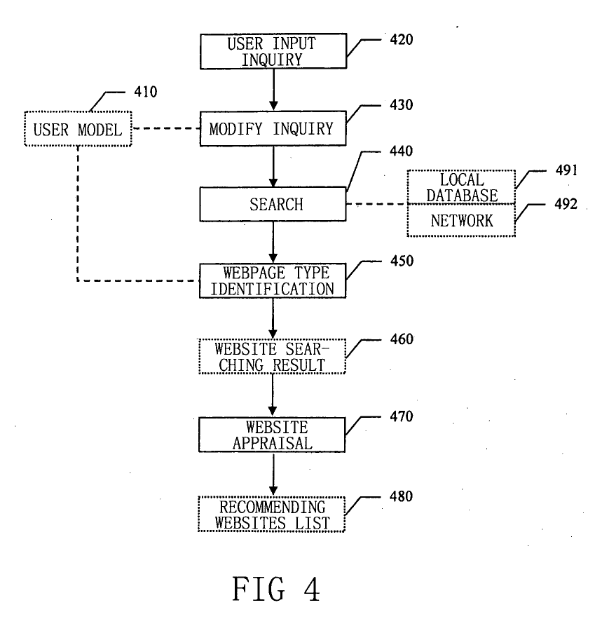

The inquiry result processing component 127 processes the results inquired by the searching component 126 to provide the user with information. The process can include ranking (see Steps 350 and 470), webpage recognizing (see Step 450), and clustering (see Step 370) etc. FIG. 3 shows a flowchart illustrating the process of a sample inquiry component and the process of templet generation according to one embodiment of the present invention. FIG. 4 shows the process of website inquiring according to one embodiment of the present invention. Processes of the inquiry component 121 and the inquiry result processing component 127 will be described in detail below with reference to FIGS. 3 and 4.

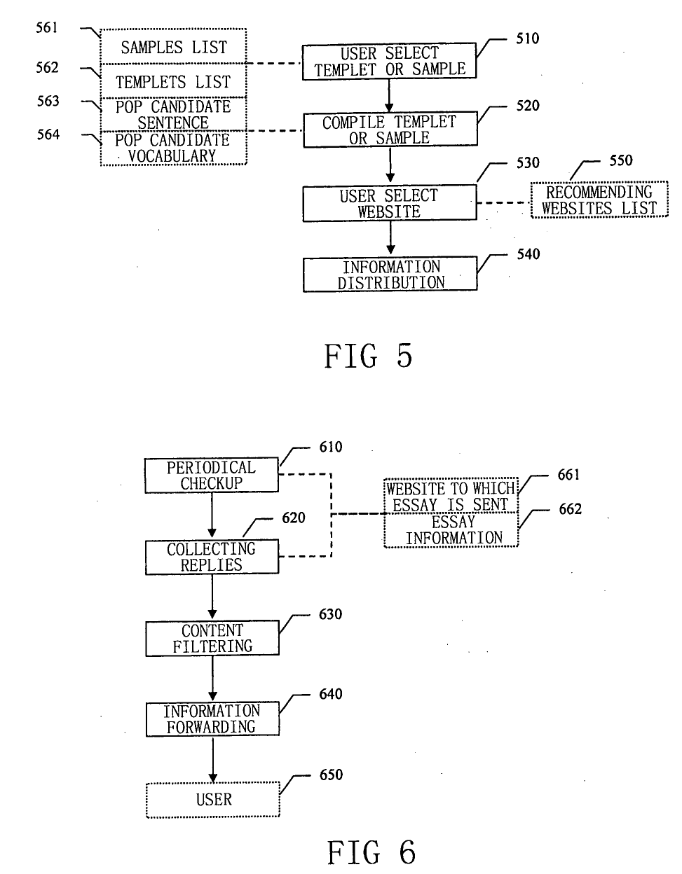

The information distributing component 123 is a component that helps the user complete information distribution on the basis of-inquiring. FIG. 5 is a block diagram illustrating the information distributing component 123 according to one embodiment of the present invention. The information distributing component 123 will be described in more detail below with reference to FIG. 5.

After the information has been distributed, since the information is usually distributed in several websites, in order to get the reply information, it is a common practice for the user to incessantly access the websites to which his information or essay has been sent to obtain the latest reply information. This costs the user a lot of time and energy. To solve this problem, the present invention provides the information tracking component 124. The information tracking component 124 automatically tracks the replies to the user. FIG. 6 is a block diagram illustrating the information tracking component 124 according to one embodiment of the present invention. The information tracking component 124 will be described in more detail below with reference to FIG. 6.

Reference is now made to FIG. 2 to describe in detail the process performed by the user model component 122 according to the present invention.

As shown in FIG. 2, the user model component firstly constructs a user account in Step 210 to differentiate each user. The user account is an identifier of the templet of the user, and each user account corresponds to one user insofar as registered accounts are concerned. The user model to which the user account corresponds provides the user with personalized information services. As for anonymous users, a user account corresponds to one type of users. For instance, different user accounts can be constructed according to the regions of the users. Genders and ages of the users can all correspond to one user account. The user account can be constructed in various ways. For instance, a database can be simply constructed for the user account.

User information 260 of the user, namely information for constructing the user model, is subsequently collected in Step 220. The user model component 122 can obtain the information for constructing the user model in a discernible mode (or an explicit mode) and/or an indiscernible mode (or an inexplicit mode). Information obtained via the discernible mode indicates registration information of the user and information required for the user to input during running process of system, while information obtained via the indiscernible mode indicates such information as inquiry words frequently used by the user, web pages frequently browsed by the user, online timing, online location and reading convention of the user collected in a non-interactive mode. The user information 260 includes, but is not limited to, the following:

personal information 261: such as address, telephone number, age, gender, vocation, level of education, income, and hobbies, etc.;

user descriptions 262: are more detailed information provided by the user to facilitate optimization of inquiry results and expression of retrieval objectives. User descriptions can assume many forms, as the user can make a detailed description of his general interests, and can also provide the webpages and websites related to his interests. During a certain retrieval action by the user, the user can also provide more detailed descriptions than keywords, and this is also a form of user description. For instance, after the user inputs the keyword “apple”, the following paragraph of description can be added: “I want to learn information concerning models, quotations, parameters, appraisals and pictures about the latest products of Apple PC computers, as well as news information, markets, appraisals and dealers of Apple PC computers”; alternatively, the user may provide some websites or sample documents relevant thereto, http://www.apple.com.cn/getamac/whichmac.html for example, to indicate that user interest lies in “Apple computers” rather than, say, brands of clothes or fruits.

user retrieval history/log 263: including keywords used, and access records of inquiry results, etc.;

interactive information 264: including direct feedback of the user, and detailed description of a certain information distribution procedure by the user, etc. Interactive information 264 of the user is the key information to modifying user models and providing more precise personalized services. Interactive information of the user can be divided into the discernible mode and the indiscernible mode. The discernible mode user interaction indicates direct feedback from the user on the results of the retrieval or distribution in the process of a certain information service. The system is notified as to which results are more conforming to the need of the user. Such feedback can be directly used for modifying a user model optimization system. The indiscernible mode interactive information is for instance clicks on the samples or the reading time during the process the user selects samples or templets; and

user group information 265: a user group is a set formed of similar users under a certain classification system. User group information is information obtained after synthesizing the information of the user group, and such information reflects some common information shared by the users in the user group. User group information 265 can function to supplement and modify the user model.

Similar users can form a user group, but one concept should be clarified in this context: the concept of “user interest” is a topic, or in other words, a topic in which the user is interested at a certain time or during a certain phase, rather than the “interest” as understood in the sense of interests and hobbies. For instance, if a user pays attention to “Olympic Games 2008”, the system will construct a topic concerning “Olympic Games 2008” during the process the user makes use of the system to inquire, to indicate a point of interest to which the user currently pays attention. After completion of the Olympic Games, the user may never again inquire any content concerning “Olympic Games 2008”, by which time this “interest” or “topic” will vanish. When the user inquires the “interest” or “topic” about “Olympic Games 2008”, the system can search among currently available users to find out whether there is someone who has made inquiry concerning this topic, and then optimize the inquiry of the current user in accordance with data of the currently available users who have made inquiry concerning the topic. Information of the user group can be utilized here, and individual information of users can also be utilized; if users paying attention to this interest are sufficient enough, a user group can also be formed according to this interest.

As should be noted, user information as listed above is merely exemplary in nature, as it is possible for a person skilled in the art to collect specific information on demand of specific applications.

Then in Step 230, the user model is constructed on the basis of the collected user information 260. A well constructed user model should be able to reflect features and interests of the user and keep track of the changes of the user interests.

The method of inference engine, the method of space vector model, the method of language modeling, the technology of ontology and the method of direct extraction can be used to construct a user model. See the following documents for the method of inference engine: Data & Knowledge Engineering, Studer R Fensel D Fensel D 1998/25/1-2; RACER System Description, University of Hamburg, Computer Science Department, Volker Haarslev; Jena2.2 (beta).released, http://jena.sourceforge.net/; See the following documents for the method of space vector model: Salton, G, the SMART Retrieval System—Experiments in Automatic Document Processing. Prentice-Hall, Englewood. Cliffs, N.J., 1971, Salton, G., Dynamic Information and Library processing. Prentice-Hall, Englewood Cliffs, N.J., 1983; See the following documents for language modeling: Jay M. Ponte and W. Bruce Croft. A language modeling approach to information retrieval. In Proceedings of SIGIR, pages 275-281, 1998, Hugo Zaragoza, Djoerd Hiemstra, and Michael Tipping, Bayesian extension to the language model for ad hoc information retrieval. In Proceedings of SIGIR, pages 4-9, 2003.

In one embodiment of the present invention, the user model is divided into two levels, the first of which is a user general model UMg, on the basis of which respective user interest models UMs can be constructed with respect to different interests of the users. In other words, two types of models are constructed, namely, a type of general model and a type of interest model.

User general model indicates a model containing general information of the users, and can be obtained for instance by extracting information from the user personal information 261 (such as address, telephone number, age, gender, vocation, level of education, income, and hobbies) or by performing inference engine analysis or vector analysis on user descriptions.

User general model is usually present in the form of an RDF ternary group (resources, attributes, declarations or attribute values), for instance, such attributes as address, telephone number, age, gender, vocation, level of education, income, and hobbies etc. are respectively assigned with attribute values. The following concrete example shows a simplified user model description. User general model can be described in terms of an attributes list. The attributes list is a formalized description of the user model, in which the attributes and attribute values will be used as bases for inference in personalized retrieval.

```
<UMg ID= “000001”>
  <USER_NAME>user1</USER_NAME>
    <USER_AGE>26</USER_AGE>
    <USER_SEX>female</USER_SEX>
    <USER_OCCUPATION>Business
    manager</USER_OCCUPATION>
  <USER_EMAIL>user1@gmail.com</USER_EMAIL>
    <USER_CATEGORY>individual</USER_CATEGORY>
    <USER_QUERY_WORDS>toyota;car</USER_QUERY_WORDS>
    <USER_HOBBY>sport</USER_HOBBY>
        ... ...
</UMg>
```

The above user model describes a user 1. As can be seen therefrom, user 1 is a female business manager aged 26, who likes sports and often retrieves Toyota cars.

In such a general model, Hobby is the overall hobby of the user rather than directed to a specific topic, for instance, the user's fondness of “sports” and the user's current attention to “Olympic Games 2008” are two types of different interests.

User interest model UMs is one constructed with regard to a specific information requirement of the user, for example, the requirement to rent a house or to buy a car. Since there are relatively great differences between different information requirements, it is impossible to use a unified model to indicate them; moreover, with regard to certain information requirements, the points of interests of the user usually vary with elapse of time. There is hence a need to construct a specific user interest model for each information requirement, and to incessantly modify the model with variations in interests of the user. When a user submits an information request (inquiry request, for instance, when the user submits an inquiry about “apple”), the system will construct an interest model in accordance with the specific information requirement as submitted by the user (at this time the user interest model is constructed according to the user's inquiry request for “apple”). When there has already been such an interest model, it is possible to modify the interest model according to the submission of the information request by the user. Construction of the user interest model UMs is based on the user general model UMg, and retrieval words and descriptions of the user, and positively sampled documents provided by the user. That is to say, construction of the interest model not only utilizes personal information 261, user description 262, retrieval history/log 263, interactive information 264, and user group information 265, but also makes use of the user general model. During the process of constructing the user interest model, adjustment will be made according to the general model of the user. For instance, as regards the user interest model of “apple”, information concerning “notebooks” and “computers” will be filled in the user interest model in accordance with the user's interest in computers in the user general model and the inquiry results of Apple notebooks in the inquiry history.

One user interest model is exemplified as follows (what is shown after each word is the weight thereof in the interest model):

| | |
|---|---|
| apple | 0.92 |
| notebook | 0.91 |
| computer | 0.9 |
| information/message | 0.89 |
| market | 0.88 |
| appraisal | 0.88 |
| dealer | 0.86 |
| desktop | 0.78 |
| configuration | 0.76 |
| memory | 0.75 |
| hard disk | 0.75 |
| basic frequency | 0.73 |
| graphic card | 0.72 |
| price | 0.68 |
| new product | 0.66 |
| model | 0.65 |
| mouse | 0.56 |
| display | 0.55 |
| software | 0.52 |
| operating system | 0.52 |
| information | 0.5 |

This model can be saved in the form of a table, and can also be saved in the following form:

```
  <USER_QUERY_WORDS>apple</USER_QUERY_WORDS>
  <WEIGHT>0.92</ WEIGHT >
    ......
  <USER_QUERY_WORDS>information</USER_QUERY_WORDS>
<WEIGHT>0.5</ WEIGHT >
```

During the specific process of constructing the model, information for model construction can for instance be extracted from personal information 261 by using the keyword extraction method, for example, female in the above model can be obtained according to the keyword “gender”.

User description 262 is also key information to construct the user model. For instance, sample document provided by the user (as noted above, sample document provided by the user is a type of user description, and the user can submit his description in the form of inputting text or in the form of the sample document or website) can be used to extract keywords (for instance, extraction can be performed by using vector space model) to indicate the interest of the user (weight of each term in the vector space model).

Vector space model is a type of description mode of the user interest model UMs. The vector space model is obtained from a document vector. For instance, under a vector space model, document vector W(ti) is defined as:

W(ti)=log(TF(ti,d)+1)×log((N/DF(ti,d))+1)

where word frequency TF(ti,d) indicates the appearing frequency of term ti in document d, document frequency DF(ti,d) indicates the number of document(s) in which ti appears at least once, N is the total number of documents, and log indicates logarithmic operation, which may be Brigg's logarithm or Napierian logarithm, etc.

As for utilization of the searching history/log 263, in specific instances, keywords in the searching history can be ranked according to word frequencies, and serve as trigger conditions of the inference engine in the specific retrieval procedure. For instance, if there is large quantity of information in the retrieval history of the user concerning the field of computers and personal PCs, it can be determined that the user's interest lies in the field of computers, so that when an ambiguous query word is input by the user, the system will adjust based on the aforementioned information. For instance, when the user inputs the keyword “apple”, the system will learn by inference that the user's retrieval tendency is directed to the brand “Apple” in the field of computers.

It is also possible to classify the keywords in the searching history to construct one vector for each class, wherein weight of each term in the vector can be calculated by using word frequencies. The following calculation formula is employed in a specific embodiment:

Ti=log(1+tfi),

where Ti indicates the weight of this term, namely the weight of the vector space model, and ffi indicates the appearing frequency of this term.

User interaction 264 can be used to construct and modify the user model and provide more precise personalized service. Positive documents and negative documents obtained from feedback of the user can be used to construct and modify the vector space model of the user. And keywords obtained from feedback of the user can be added to the user model of the user (for instance, in the form of an information list).

User group information 265 can function to supplement and correct the user model. The user group is a set formed of similar users under a certain classification system. Use of user group information can correct the current user model. During the process of constructing the user model, users having interests identical or similar to those of the designated user can be found in the user group by the method of cooperative filtering, and prediction of degree of fondness of the designated user on a certain information is formed in the system by synthesizing the appraisals of the information by these identical or similar users.

Before or after model construction, the technology of ontology can be used to construct a classification words list for each attribute value of each attribute manually, or automatically by the method of machine learning. Take for an example of constructing a classification words list for occupation attributes, common words pertaining to a certain occupation are incorporated into the words list. In practice, words commonly used in the IT field greatly differ from words commonly used in the field of finance. Such classification words lists can be used for inquiry expansion or participate in the re-ranking and filtering of inquiry results in the form of vectors. For instance, “computers” can be expanded into “electronic computers”, “notebooks”, “desktops” and “servers” etc.

As a conceptualized illustration, “ontology” is the description of objectively existent concepts and relationships in the engineering technology. It is a “definitive set of concepts” in the general sense, and is a vocabulary list relevant to “classes and types” and “relationships”.

The system can expand such information provided by the user as age, gender, occupation and level of education through the current ontology or through ontology obtained by performing statistics on a large number of users. For example, an ontology can be constructed for such information as common words and hotspots of interest of users with differing occupations, and to be expanded with regard to specific users in accordance with the ontology.

In addition, as should be noted, the above Step 220 is repetitively carried out. In other words, user information 260 is incessantly collected during the running process of the system, and learning process is performed (Step 250) to update the user model (Step 240).

Sample inquiry process of the inquiry component 121 according to one embodiment of the present invention is described below with reference to FIG. 3. The inquiry component 121 provides personalized information retrieval in accordance with inquiry words of the user and the user model constructed by the user model component. The inquiry includes inquiry of samples and inquiry of websites. The inquiry component according to the present invention further comprises the function of templet generation.

As shown in FIG. 3, firstly in Step 320, the user inputs an inquiry word (inquiry condition). Subsequently, the system modifies the inquiry condition (Step 330). The system firstly expands the inquiry condition in accordance with the user model 310. For instance, if the user inputs the inquiry word “apple”, the system will expand the inquiry word in accordance with the user templet, in which the field <USER_QUERY_WORDS> indicates inquiry words already used by the user. The system performs expansion by using the words in this field. If the field <USER_QUERY_WORDS> in the user model contains such an inquiry word as “computer” (for example, there is <USER_QUERY_WORDS> computer</USER_QUERY_WORDS>), this indicates that the inquiry words frequently used by the user are concentrated in the field of computer, and this inquiry word will be added with expansion words such as “electronic computers” and “notebooks” etc. As should be noted, the process of expanding the inquiry can be retroactive, and the system can automatically increase or decrease the inquiry words to ensure sufficient number of documents retrieved by judging the number of inquiry results. The system expands the inquiry through such a process.

Subsequently, retrieval is performed in accordance with modified inquiry conditions (Step 340). On the basis of the modified inquiry conditions, the system retrieves on a local database 391 and a network 392 to obtain the preliminary retrieval result.

The aforementioned Steps 320, 330 and 340 can be accomplished by the inquiry component (sample inquiry component).

On the basis of the retrieval result (inquiry result), the system filters and re-ranks the retrieval result in accordance with the user model (Step 350). This process can be carried out with many methods. For instance, it is possible in one specific embodiment to make the user model into the form of a vector space model, and document similarity between the retrieval result and the user model (in the form of a vector space model) can then be utilized to rank documents of the inquiry results. Specifically, the similarity between two documents is represented by an angle between the vector space models:

$$Sim ( {D}_{1} , {D}_{2} ) = cos θ = \frac{{\sum }_{k = 1}^{N} ( {w}_{1 k} \times {w}_{2 k} )}{\sqrt{( {\sum }_{k = 1}^{N} {w}_{1 k}^{2} ) ( {\sum }_{k = 1}^{N} {w}_{2 k}^{2} )}}$$

where sim (D₁,D₂) is the similarity between the two documents, W₁ₖ is the weight of each term in Document 1, W₂ₖ is the weight of each term in Document 2, and N is the number of total terms in Documents 1 and 2.

On the basis of the above, webpages are ranked by such factors as the number of reviews of the webpages, number of replies to the webpages, ratio of trash information in the replies, number of references and in conjunction with the level of authority, scale and power of influence of the website. The webpage mostly satisfying the retrieval requirement of the user is ranked at the foremost. Inquiry results filtered and re-ranked as thus can be used as samples for the user to select. The user can make compilation by browsing the inquiry results and selecting one therefrom.

In short, document similarity is used in the aforementioned methods, whereby those whose weights are lower than a threshold value are filtered out, and those whose weights are higher than the threshold value are re-ranked according to magnitudes of similarities.

The system simultaneously provides another service, i.e. to aggregate several samples into a writing templet through clustering and abstracting (Step 370) on the basis of samples obtained via retrieval. The user may choose to make compilation on this templet. Since the templet is formed by synthesis on the basis of great quantities of samples, its format and wording are the most frequently used and most attractive to the user amongst the great number of samples. The user makes modifications on the basis thereof to thereby save much time and guarantee quality of essays put online.

At the same time of making compilation by the user, the system can provide pop vocabularies and sentences for the user to select. The hot vocabularies and sentences are also realized by using the clustering technology.

The aforementioned steps 350 and 370 can be accomplished by an inquiry result processing component. In one embodiment according to the present invention the inquiry result processing component includes, for instance, a filtering unit for filtering the inquiry results obtained by the inquiry unit, a ranking unit for ranking the filtered inquiry results, and a clustering unit for clustering ranked inquiry results 360 and generating a templet list 382, a pop candidate vocabulary 383 and a pop candidate sentence 381.

In addition, during the process of retrieval, the system can obtain feedback from the user either in a discernible mode or in an indiscernible mode, and modify the user model by using the feedback. In one specific embodiment, spurious correlation feedback algorithm is used in correcting the model. Spurious correlation feedback algorithm is a machine self learning algorithm based on a method of feedback proposed by Rocchio in 1971:

$${p}_{n + 1} = \{ \begin{matrix}{p}_{n} + α {D}_{n + 1} & if {D}_{n + 1} relevant \\ {p}_{n} - β {D}_{n + 1} & if {D}_{n + 1} irrelevant\end{matrix}$$

Since there might be many results returned, it is impossible for the user to feed the results back one by one in the environment of practical application. Under such a circumstance, appraisal samples of the results as can be actually obtained from the user may be very sparse. In order to solve this problem, it is assumed that there is relatively low similarity to the model as to the documents to which no feedback is made by the user, and the result is also irrelevant. But such “irrelevancy” cannot be sometimes equated with results actually marked up as “irrelevant” by the user. We therefore adjust the Rocchio formula as follows:

$${P}^{′} = {P}_{0} + {α}^{*} {\sum }_{{D}_{i} ∈ {T}_{rel}} {D}_{i} + {α}^{′ *} {\sum }_{{D}_{j} ∈ {T}_{part \_ rel}} {D}_{j} - {β}^{*} {\sum }_{{D}_{k} ∈ {T}_{irrel}} {D}_{k} - {β}^{′ *} {\sum }_{{D}_{l} ∈ {T}_{part \_ irrel}} {D}_{l} - {β}^{″ *} {\sum }_{{D}_{m ∈ {T}_{undet}}} {D}_{m}$$

where Tᵣₑₗ, Tₚₐᵣₜ_{_{—}}ᵣₑₗ, Tᵢᵣᵣₑₗ, Tₚₐᵣₜ_{_{—}}ᵢᵣᵣₑₗ, T_{undet} respectively indicate relevant document sets, partially relevant document sets, irrelevant document sets, partially irrelevant document sets and undetermined document sets, α, α′, β, β′ and β″ respectively indicate their weights, P₀ is the coefficient before the adjustment, and p′ is the coefficient after the adjustment. The relevant document sets indicate sets of documents that are relevant to the inquiry of the user. Certain inquiry results can be listed during the process of interaction with the user to let the user determine as to “relevant”, “partially relevant”, “irrelevant” or “partially irrelevant”, of which “relevant” means that the user himself considers the document as conforming to his inquiry requirement, whereas “partially relevant” means that the user considers the document as not entirely conforming to his inquiry requirement, but that the document can be considered as relevant in certain degrees. In other words, “relevant”, “partially relevant”, “irrelevant” and “partially irrelevant” are judgments by the user as regards the degrees of relevancy to the document. Since the chance to get the feedback from the user and the documents fed back are very scarce, most documents are not fed back by the user, and these documents are classified as “undetermined”. In comparison with the Rocchio formula, we include the partially relevant document sets, the partially irrelevant document sets and the undetermined document sets into the formula, and use coefficients α′, β′ and β″ to indicate their weights. Parameters in the formula can for instance be set as α=1.0, α′=0.5, β=1.8, β′=0.5, β″=1.8.

The personalized retrieval process further includes retrieval of websites. FIG. 4 illustrates a website retrieval process according to one embodiment. This process is similar to templet retrieval. In this process the user model also functions for application in the fields of inquiry expansion and defining the inquiry. As exemplified above, if the user inputs such an inquiry as “apple”, it is expanded according to the user model into “apple, computer, notebook”, and it is hence possible to retrieve websites relevant only to computers in the process of website retrieval. What is different in website retrieval is the need to perform webpage type identification (Step 450) to differentiate as to whether the webpage is the home page or the index webpage of the website. Through webpage type identification, the home page, index webpage and sub-index webpage are merely retained, while the remaining webpages of the website are discarded.

After acquisition of the needed webpages, it is necessary for the system to perform appraisal ranking on the website (Step 470). The process of appraisal includes, for instance, firstly collecting various information on the website including level of authority, scale, power of influence, number of users, amount of accesses, average number of user browsing, etc. A weighted average of each information is then calculated as shown by the formula: w=Σwᵢpᵢ, where pᵢ indicates each criterion for appraising the website, and wᵢ is the corresponding weight. The finally obtained w is the appraisal result of the website. The w after being ranked can serve as the priority for information distribution and are recommended to the user as a recommended website list (Step 480). As should be noted, appraisal of the website can be accomplished in advance, and can be timely updated. Therefore, in one embodiment according to the present invention, Step 470 can be directed merely to ranking the relevant websites.

The above Steps 450 and 470 can be accomplished by the inquiry result processing component. In the embodiment according to the present invention, the inquiry result processing component 126 includes, for instance, a webpage type identifying unit for performing webpage type identification on the inquiry results obtained by the inquiry unit and retaining only those webpages capable of representing the website, a website appraising unit for appraising the identified websites, and a website ranking unit for ranking the websites according to the appraisal result. As described above, the website appraising unit can be omitted. The appraisal result can be saved in advance by a storage unit, and the website ranking unit can review the appraisal result saved by the storage unit when ranking the websites.

The distributing component 123 according to the present invention is described below with reference to FIG. 5. The information distributing component 123 is a component part that assists the user to accomplish information distribution on the basis of retrieval. FIG. 5 shows the system block diagram of a specific embodiment. During such a process, the system guides the user to complete the process of information distribution by a plurality of modes. As shown in FIG. 5, in a specific embodiment, the ranked inquiry results (namely a samples list) (Step 561) are presented to the user, and the user can make judgment on the listed samples on the basis of the inquiry results, selects one templet therefrom as a model essay (Step 510), and makes modifications on the basis of this model essay (Step 520). After the user finishes the modification process, the system will recommend websites (Step 550) available for information distribution with regard to the retrieval of the user for the user to select, and after the user selects the website to distribute information (Step 530), the system automatically distributes the information of the user to the website designated by the user (Step 540) so as to complete an information distribution process. The process of distribution can be realized with many methods. For instance, the process of distribution can be realized by analyzing the table and form of a forum, and submitting the information through program simulation.

In another specific embodiment, the system synthesizes different documents together by clustering and automatic abstracting technologies on the basis of the inquiry results to form several writing templets (templets list) of different styles (Step 562).

As should be noted, the above descriptions of the present invention are exemplary rather than exclusive. For instance, the user may not necessarily select the website to which the information is to be distributed, while the distributing component instead distributes the information to all websites capable of information distribution. In this case, the user can be notified of the circumstances of distribution (such as the website to be distributed and the distribution results, etc.). On the other hand, it is also possible to merely distribute to the foremost several websites, for instance, the foremost 10 websites.

A specific instance of the clustering method is described below with messages on BBS as examples—we define certain nouns as follows for the sake of convenience:

Message: indicating a certain essay published by an author with regard to a certain subject, whose synonyms include essay, message, and post. Message is divided into two types, one of which is start message and another of which is reply message. The former is the first message within the clue, and the latter is the reply to a certain message within the clue.

Clue: a set of discussions formed of one start message and several reply messages, whose synonyms include topic, discussion, and subject etc.

Discussion Area: an edition on BBS set around a certain field, whose synonyms include forum, edition, and message board.

Writer: the person who distributes a message, whose synonyms include author and poster.

Reviewer: the person who reviews a message, whose synonyms include reader and viewer.

At the beginning of clustering, selection of feature words is firstly performed on the message to take high-frequency feature words (namely those whose word frequencies>=2 in practical operation) as terms in a vector space model (VSM), and feature words that appear in the start message caption and start message content are assigned with higher weights. Specific weight assigning algorithm uses tf×idf formula, i.e. the weight of word tk is tfₖ×idfₖ, where tfₖ indicates the number of frequencies of the word tk in a certain message set, idfₖ indicates the reverse of the number of frequencies of documents of the word tk. That is, idfₖ=log(N/nₖ), wherein N indicates the total number of a certain type of messages, and nk indicates the number of messages in which word tk appears.

After selection of feature terms, a vector matrix is constructed, in which the row represents the i^{th} tree (labeled as Treei), the column represents the j^{th} term (labeled as Termj), and elements of the matrix are labeled as Value(i,j); it is calculated by the following formula:

$$Value ( i , j ) = \{ \begin{matrix}1.5 * {f}_{ij} * {idf}_{j} , & \begin{matrix}if Termj appears in the caption of \\ start message of Treei\end{matrix} \\ 1.2 * {f}_{ij} * {idf}_{j} , & \begin{matrix}if Termj appears in the content of \\ start message of Treei \end{matrix} \\ {f}_{ij} * {idf}_{j} , & others \end{matrix}$$

where fij indicates the number of frequencies by which Termj appears in Treei. The fact that terms appearing in the start message are assigned with greater weights is because these terms are considered to be more important.

n is used to indicate dimensionality of the vector, m indicates the number of clue trees, k indicates the number of clusters, X={xᵢ, i=1,2, . . . , m} indicates the set of clue trees, and N indicates the maximum number of times of iteration. The basic K-Means clustering algorithm is as follows:

Output:
Yⱼ, j=1,2, . . . , k—the final clustering center, represented by vector
Kⱼ, j=1,2, . . . , k—the final clustering set (a forest set formed of a plurality of clue trees)

Steps:
Step 1: K number of clustering centers are selected at random: Y₁, . . . , Yj . . . ,Y_{K}; Kⱼ=φ, j=1,2, . . . k
Step 2: calculate the similarity between xᵢ(i=1,2, . . . , m) and each clustering center, then place xᵢ into the most similar class Kⱼ, i.e. Kⱼ=Kⱼ∪{i}, similarity is calculated by the following cosine formula:

$$Sim ( {x}_{i} , {Y}_{j} ) = \frac{{\sum }_{l = 1}^{n} {x}_{il} * {y}_{jl}}{\sqrt{( {\sum }_{l = 1}^{n} {x}_{il}^{2} ) ( {\sum }_{l = 1}^{n} {y}_{jl}^{2} )}} ;$$

Step 3: calculate the clustering center again:

$${y}_{j} = \frac{( {\sum }_{i ∈ {K}_{j}} {x}_{i} )}{{m}_{j}}$$

(mⱼ is the size of the cluster)
Step 4: if the cluster remains unchanged or is changed slightly, or the number of times of iteration is already N, stop; otherwise, return to Step 2.

One essential problem in the K-Means algorithm is the selection of K, as this directly relates to the number of candidate topics as clustered. We use ThreadNum to indicate the number of clues, and determine the number of k by the following formulae:

```
if (ThreadNum<=10) k=└ThreadNum/2┘
if ((ThreadNum>10) && (ThreadNum<=100))
  k=└ThreadNum/4┘
if ((ThreadNum>100) && (ThreadNum<=1000))
  k=└ThreadNum/5┘
if (ThreadNum>1000) k=└ThreadNum/8┘
```

The result of such clustering is that the system obtains k number of clustering sets, each of which represents an essay of similar content. The next operation is to obtain a writing templet by the method of automatic abstracting on the basis of each cluster. In this embodiment, each essay is paragraphed by using a multi-documents abstracting method based on clustering, and clustering is performed on the basis of the paragraphing result; one paragraph nearest to the clustering center is selected as the kernel paragraph for each cluster, and all kernel paragraphs are combined to serve as the final templet.

The user can make compilation on the basis of the templet. Since the templet is formed by synthesis on the basis of great quantities of samples, its format and wording are the most frequently used and most attractive to the user amongst the great number of samples. The user makes modifications on the basis thereof to thereby save much time and guarantee quality of essays put online. During the process of compilation, the system provides vocabulary (564) and sentences (563) in vogue for the user to select.

The information tracking component 124 provides tracking services after information has been distributed. Since the information is usually distributed to several websites, in order to review the information in reply to the information, it is necessary for the user to incessantly access the websites to which the information has been distributed to obtain the latest reply information. This costs the user much time and energy. Under certain circumstances, for instance the user distributes house renting information on each housing leasing website to rent an apartment, important information might be missed due to the failure to look over information replied to the user. To save time of the user, the system provides a function to automatically track replies to the user; see the block diagram in FIG. 6 for details. On learning such essential information as the user's essay and the circumstances of the websites to which the essay has been sent, the system timely checks (Step 610) these websites and tracks replies to the user's essay, timely collects new replies (Step 620), and forwards them to the user in the mode selected by the user (the forwarding modes include, but are not limited to, email, RSS, short message, and websites concentrically provided by the system, etc.) (Step 640).

Another problem in the replies to the user is that there are usually many trash information in the replies, such as meaningless replies and spams, etc., and forwarding of such information to the user also costs the user much time. In order to solve this problem, the system provides a content filtering function (Step 630) to remove the trash information from the replies, and merely forwards the useful information to the user. There are many methods to filter trash information, and currently available classifying methods can all be employed to filter trash information. In one specific embodiment, we employ the Naïve Bayesian Classifier to carry out the task: see the following specific steps:

Training Phase

It is firstly necessary in the training phase to determine the number of classes, for instance, they can be divided into the three classes of valuable information, neutral information and trash information. Of course, it is also possible to divide into more classes according to the need of particularization or only into two classes (trash information, non-trash information)
i. Preprocessing of the message, including removing taboo words, extracting stems, and dividing sentences, etc.;
ii. Collecting, training and concentrating all words to obtain a vocabulary list;
iii. Calculating a priori probability of each class vj:

$$P ( {v}_{j} ) = \frac{number of messages under the class}{total number of trained messages}$$

iv. Calculating conditional probability:

$$P ( {w}_{i} \vert {v}_{j} ) = \frac{{n}_{i} + 1}{n + N}$$

Notes: wᵢ represents the i^{th} word in the vocabulary list, vⱼ is a class of the classification, nᵢ indicates the times by which wᵢ appears in the class vⱼ, n indicates the number of all words in the class vⱼ, and N indicates the number of vocabularies in the vocabulary list. We employ the Plus-One approach to estimate the probability of an event that does not come forth.

Classifying Phase
i. Preprocessing the message, to perform such preprocessing operations as removing taboo words and extracting stems, etc;
ii. Calculating the target value of the message by using the following formula, to obtain the class of each message:

$$v = {arg max}_{{v}_{j ∈ V}} P ( {v}_{j} ) {\prod }_{{w}_{i} ∈ msg} P ( {w}_{i} \vert {v}_{j} ) .$$

The present invention relates to a system and a method that make use of a user model to provide personalized information distribution services based on information relevant to corresponding user features.

As should be noted, the above descriptions are only exemplary in nature. For instance, in the above descriptions, generation of the sample templets, pop candidate sentences and pop candidate vocabularies is accomplished in the sample inquiry component, but can also be accomplished in the information distributing module.

When applied in the present application, such technical terms as “component”, “service”, “model” and “system” are intended to mean the following entities relevant to a computer: hardware, combination of hardware with software, software, or software in execution. For instance, the component can be, but not limited to, a process running on a processor, a processor, an object, an executable component, an executing thread, a program and/or a computer. For the purpose of illustration, application running on a server and the server are all components. One or more components can reside in executing process and/or thread, and the component(s) can be localized on one computer and/or arranged between two or more computers.

1. An information distribution system, characterized in comprising:
an inquiry condition determining component, for constructing inquiry conditions in accordance with a user input and a user model, the user model being applicable for determining features of the user;
a searching component, for performing inquiry in accordance with the inquiry conditions;
an inquiry result processing component, for processing inquiry results obtained by the searching component to provide the user with processed information; and
a distributing component, for distributing information compiled by the user and to be distributed.

2. The system according to claim 1, characterized in further comprising a user model component for obtaining information used for constructing the user model in a discernible mode and an indiscernible mode and for constructing or updating the user model in accordance with the obtained information, wherein the information obtained by the discernible mode indicates registration information of the user and information required for the user to input during running process of system, and wherein the information obtained by the indiscernible mode indicates inquiry words frequently used by the user, web pages frequently browsed by the user, online timing, online location and/or reading convention information of the user collected in a non-interactive mode.

3. The system according to claim 2, characterized in that the user model component adjusts and updates the user model in accordance with user feedback, inquiry results, user compilation results, the web site selected for distribution and/or information distribution tracking results.

4. The system according to claim 1, characterized in that the searching component inquires samples, and that the inquiry result processing component ranks the samples obtained via inquiry to provide the user with searching results of the ranked samples for the user's selective compilation in accordance with relevancy or time, or in accordance with the number of returned essays, and times of lookups of the inquired samples, and an authoritative degree of the web site to which the essays belong, or in accordance with the user model.

5. The system according to claim 1, characterized in that the searching component inquires samples, and that the inquiry result processing component clusters the searching results of the samples, generates a distribution templet, candidate sentences and candidate vocabulary on the basis of the clustering, and provides the user with the distribution templet, the candidate sentences and the candidate vocabulary for the user's selective compilation.

6. The system according to claim 1, characterized in that the searching component inquires web sites capable of performing information distribution, and that the inquiry result processing component ranks the inquired web sites in accordance with the user model or authoritative degrees, degrees of demand, numbers of users and/or geographical attributes of the web sites.

7. The system according to claim 6, characterized in that the inquiry result processing component performs type recognition of the web pages before ranking, and retains only those web pages representative of the web sites.

8. The system according to claim 6, characterized in further comprising an information tracking component for tracking effects after the user has distributed information, feeding back to the user replies to and comments on the information distributed by the user in each web site, wherein the information tracking component transmits the tracking information to the user in modes of RSS, email and/or online display.

9. The system according to claim 8, characterized in that the user model comprises a user general model and a user interest model.

10. An information distribution method, characterized in comprising:
an inquiry condition determining step, constructing inquiry conditions in accordance with a user input and a user model, the user model being applicable for determining features of the user;
a searching step, performing inquiry in accordance with the inquiry conditions;
an inquiry result processing step, processing inquiry results obtained in the searching step to provide the user with processed information; and
a distributing step, distributing information compiled by the user and to be distributed.

11. The system according to claim 2, characterized in that the searching component inquires samples, and that the inquiry result processing component clusters the searching results of the samples, generates a distribution templet, candidate sentences and candidate vocabulary on the basis of the clustering, and provides the user with the distribution templet, the candidate sentences and the candidate vocabulary for the user's selective compilation.

12. The system according to claim 3, characterized in that the searching component inquires samples, and that the inquiry result processing component clusters the searching results of the samples, generates a distribution templet, candidate sentences and candidate vocabulary on the basis of the clustering, and provides the user with the distribution templet, the candidate sentences and the candidate vocabulary for the user's selective compilation.

13. The system according to claim 4, characterized in that the searching component inquires samples, and that the inquiry result processing component clusters the searching results of the samples, generates a distribution templet, candidate sentences and candidate vocabulary on the basis of the clustering, and provides the user with the distribution templet, the candidate sentences and the candidate vocabulary for the user's selective compilation.
